(19) United States
(12) Patent Application Publication
(10) Pub. No.: US 2026/0100049 A1
(43) Pub. Date: Apr. 9, 2026

(54) DEVICE AND METHOD FOR IMPROVING OBJECT RECOGNITION PERFORMANCE OF AUTONOMOUS DRIVING CONTROLLER

(71) Applicant: WISE AUTOMOTIVE CORPORATION, Seoul (KR)

(72) Inventors: InSu KIM, Seoul (KR); Jae-Hong PARK, Seoul (KR)

(73) Assignee: WISE AUTOMOTIVE CORPORATION, Seoul (KR)

(21) Appl. No.: 18/941,010

(22) Filed: Nov. 8, 2024

(30) Foreign Application Priority Data
Oct. 7, 2024 (KR) 10-2024-0135329

(51) Int. Cl. G06V 20/56; B60W 50/06; G06V 10/22; G06V 10/32; G06V 10/80

(52) U.S. Cl. CPC G06V 20/56; B60W 50/06; G06V 10/225; G06V 10/32; G06V 10/809

(57) ABSTRACT

A device and a method for improving the object recognition performance of an autonomous driving controller are disclosed. According to the present disclosure, it is possible to recognize an object by using raw data received from multiple different sensors, configure an intensive processing area of the raw data based on information about a position in which the object is recognized, and reduce the amount of computation of the autonomous driving controller through object recognition inference regarding the configured intensive processing area. Furthermore, it is possible to improve the recognition performance by minimizing raw data loss while reducing the amount of computation in an inference procedure in which a large amount of computation is required for efficient object recognition.

### CROSS-REFERENCE TO RELATED APPLICATION(S)

This application is based on and claims priority under 35 U.S.C. 119 to Korean Patent Application No. 10-2024-0135329, filed on Oct. 7, 2024, in the Korean Intellectual Property Office, the disclosure of which is herein incorporated by reference in its entirety.

### BACKGROUND OF THE INVENTION

### 1. Field of the Invention

The present disclosure relates to a device and a method for improving the object recognition performance of an autonomous driving controller and, more specifically, to a device and a method for improving the object recognition performance of an autonomous driving controller wherein an object is recognized using raw data received from multiple different sensors, and an intensive processing area of the raw data is configured based on information about a position in which the object is recognized, thereby reducing the amount of computation of the autonomous driving controller is reduced through object recognition inference regarding the configured intensive processing area.

### 2. Description of the Prior Art

In general, an autonomous vehicle refers to a vehicle that can move by itself without the need for a driver to operate the vehicle.

Such an autonomous vehicle may be equipped with various sensors and cameras, and FIG. 1 illustrates the arrangement of sensors and cameras in a typical autonomous vehicle.

As shown in FIG. 1, an autonomous vehicle 10 may be equipped with a LIDAR 20, a radar 30, a camera 40, etc., may be equipment with a 3D shape recognition sensor, a camera, a laser sensor, a multi-axis motion sensor, etc. as needed, and may include a control unit 50 configured to recognize surrounding objects based on inputs received from these sensors.

The LIDAR 20 is used to detect vehicles and road facilities, and a 24 GHz short-range radar and a 77-78 GHz mid- or long-range radar may be used, and is mainly used for a front and rear collision warning or collision avoidance system, etc.

The RADAR 30 may emit laser pulses onto the ground and obstacles and analyze reflected light energy, thereby recognizing three-dimensional information about surrounds.

The camera 40 may convert light entering through a lens into a digital signal and may be applied not only to around-view and rear-view cameras but also to automatic emergency braking (AEB), lane keeping assist (LKA), etc.

In addition, the 3D shape recognition sensor is an image sensor camera with LEDs and recognition pixels, and may be used for all-round collision prevention, lane departure prevention, parking assistance, etc. A radar sensor is a sensor that uses the principle of radio waves being transmitted from a transmitter, reflected by an obstacle, and received by a receiver, and may be applied to determining a distance, speed, angle, etc.

The control unit 50 may receive inputs from sensors such as the LIDAR 20, the LIDAR 30, and the camera 40, process and infer raw data, merge the inference results to recognize surrounding objects, and perform inference by performing lossy preprocessing of the raw data if there is a need to increase the inference speed.

The sensors in the autonomous vehicle need to recognize objects in a complementary manner due to respective characteristics.

Additionally, the required amount of computation for sensors' inference, i.e., the amount of computation, may vary depending on the types of sensors, and the final recognition performance may be determined by the inference computation of the slowest sensor due to the difference in the amount of computation among the sensors.

### SUMMARY OF THE INVENTION

To solve the above-described problems, an aspect of the present disclosure is to provide a device and a method for improving the object recognition performance of an autonomous driving controller, wherein an object is recognized using raw data received from multiple different sensors, and an intensive processing area of the raw data is configured based on information about a position in which the object is recognized, thereby reducing the amount of computation of the autonomous driving controller through object recognition inference regarding the configured intensive processing area.

To achieve the above-described aspect, an embodiment of the present disclosure provides a device for improving object recognition performance of an autonomous driving controller. The device includes an object recognition module unit configured to receive raw data from multiple sensors to recognize an object, infer information about a position and a type of the object from raw data from each sensor by using a predetermined inference program, merge the inferred object recognition information for each sensor to recognize the object, and mark a raw data area, in which the object is present, as an intensive processing area and control the intensive processing area to be reflected in the raw data received from the multiple sensors.

Furthermore, the object recognition module unit according to the embodiment is configured to output a preconfigured vehicle control signal to a vehicle in response to the recognized object information.

Furthermore, the object recognition module unit according to the embodiment includes: a recognition control unit configured to receive raw data from multiple sensors, infer information about a position and a type of an object from raw data from each sensor by using a predetermined inference program, merge the inferred object recognition information for each sensor to recognize the object, mark a raw data area, in which the object is present, as an intensive processing area, and control the intensive processing area to be reflected in the raw data received from the multiple sensors; and a determination control unit configured to output a preconfigured vehicle control signal to a vehicle in response to the recognized object information.

Furthermore, the recognition control unit according to the embodiment includes: a sensor processing unit configured to preprocess raw data received from each sensor according to a preconfigured data size and format; a sensor inference unit configured to receive the preprocessed raw data and infer information about a position and a type of an object from the raw data from each sensor by using the inference program; a sensor merging unit configured to merge the inferred object recognition information for each sensor to recognize the object, and mark a raw data area, in which the object is present, as an intensive processing area; and a processing area configuration unit configured to configure the intensive processing area of the raw data to be reflected in the raw data received from the sensor and preprocessed.

Furthermore, the sensor according to the embodiment is one among a radar, a LIDAR, a camera, a 3D shape recognition sensor, a laser sensor, and a multi-axis motion sensor.

Furthermore, an embodiment of the present disclosure relates to a method for improving object recognition performance of an autonomous driving controller. The method includes: step a) in which a recognition control unit of an object recognition module unit receives raw data from multiple sensors and infers information about a position and a type of an object from raw data from each sensor by using a predetermined inference program; step b) in which the recognition control unit merges the inferred object recognition information for each sensor to recognize the object; and step c) in which the recognition control unit marks a raw data area, in which the object is present, as an intensive processing area and control the intensive processing area to be reflected in the raw data received from the multiple sensors.

Furthermore, the embodiment further includes step d) in which a determination control unit of the object recognition module unit outputs a preconfigured vehicle control signal to a vehicle in response to the object information recognized in step b).

Furthermore, step a), according to the embodiment, includes: step a-1) in which in case that raw data is received from each sensor, the recognition control unit determines whether an intensive processing area of the raw data has been configured; step a-2) in which based on the determination result, the recognition control unit preprocesses the intensive processing area of the raw data according to a preconfigured data size and format, or processes the entire raw data area according to the preconfigured data size and format; and step a-3) in which the recognition control unit outputs the processed raw data.

Furthermore, step b) according to the embodiment includes: step b-1) in which in case that the inferred object recognition information for each sensor is received, the recognition control unit determines whether the object recognition information includes information about an object type; and step b-2) in which in case that, as a result of the determination, the object recognition information includes the information about the object type, the recognition control unit updates object information recognized by merging the inferred object recognition information for each sensor, and controls a preconfigured vehicle control signal to be output in response to the recognized object information.

Furthermore, the embodiment further includes step b-3) in which in case that, as a result of the determination in step b-1), the object recognition information does not include the information about the object type, the recognition control unit controls position information of the object to be reflected in an intensive processing area of raw data received from the sensor.

Furthermore, step b-3) according to the embodiment further includes step in which the recognition control unit analyzes the position information of the object to determine whether the position information is identical to a previously configured intensive processing area, and, in case that the position information of the object is determined to be different from the previously configured intensive processing area, updates the intensive processing area of the raw data and configures the updated intensive processing area to be reflected in preprocessing.

The present disclosure is advantageous in that it is possible to recognize an object by using raw data received from multiple different sensors and configure an intensive processing area of the raw data based on information about a position where the object is recognized, thereby reducing the amount of computation of the autonomous driving controller through object recognition inference regarding the configured intensive processing area.

Furthermore, the present disclosure is advantageous in that it is possible to improve recognition performance by minimizing raw data loss while reducing the amount of computation in an inference procedure in which a large amount of computation is required for efficient object recognition.

### BRIEF DESCRIPTION OF THE DRAWINGS

The above and other aspects, features and advantages of the present disclosure will be more apparent from the following detailed description taken in conjunction with the accompanying drawings, in which:

FIG. 1 illustrates the arrangement of sensors and cameras of a typical autonomous vehicle;

FIG. 2 is a block diagram illustrating a structure of a device for improving the object recognition performance of an autonomous driving controller according to an embodiment of the present disclosure;

FIG. 3 is a block diagram illustrating a configuration of a recognition control unit of the device for improving the object recognition performance of an autonomous driving controller according to the embodiment in FIG. 2;

FIG. 4 is a flowchart illustrating a method for improving the object recognition performance of an autonomous driving controller according to an embodiment of the present disclosure;

FIG. 5 is a flowchart illustrating a raw data processing process in the method for improving the object recognition performance of an autonomous driving controller according to the embodiment in FIG. 4;

FIG. 6 is a flowchart illustrating an object information processing process in the method for improving the object recognition performance of an autonomous driving controller according to the embodiment in FIG. 4; and

FIG. 7 is another flowchart illustrating an object information processing process in the method for improving the object recognition performance of an autonomous driving controller according to the embodiment in FIG. 4.

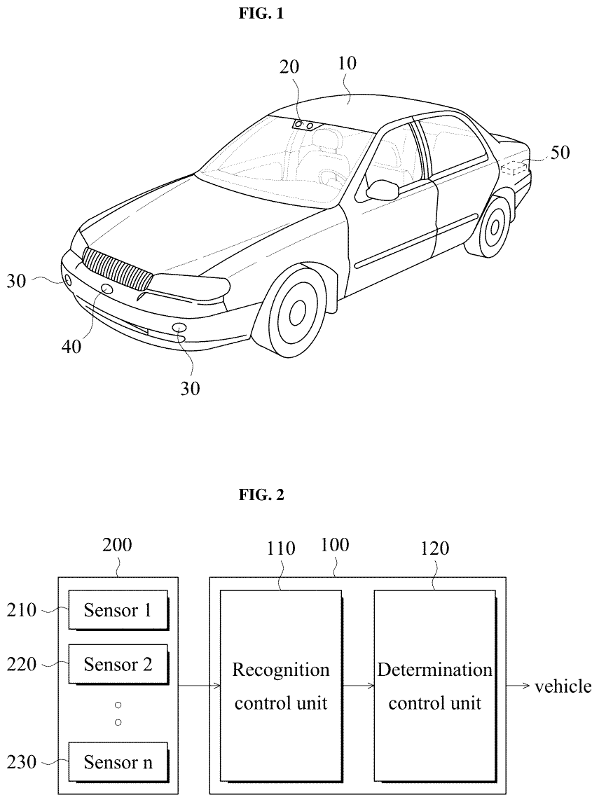

### DETAILED DESCRIPTION OF THE EXEMPLARY EMBODIMENTS

Hereinafter, the present disclosure will be described in detail with reference to a preferred embodiment of the present disclosure and the accompanying drawings, wherein the same reference numerals in the drawings denote the same elements.

Before describing the specific details for implementing the present disclosure, it should be noted that configurations not directly related to the technical essence of the present disclosure have been omitted without departing from the technical essence of the present disclosure.

Furthermore, the terms or words used in the present specification and claims are to be interpreted as meanings and concepts consistent with the technical idea of the disclosure, based on the principle that the inventor can define the concepts of appropriate terms in order to describe his/her disclosure in the best way.

In the present specification, the expression that a part “includes” an element does not exclude other elements, but rather implies that other elements may be further included.

Furthermore, the terms “ . . . unit” “ . . . device”, “ . . . module” and the like refer to units that perform at least one function or operation, and may be classified as hardware, software, or a combination thereof.

Furthermore, the term “at least one” is defined as a term including both singular and plural forms, and it will be evident that even in the absence of the term “at least one”, each element may exist in either singular or plural form, and may denote singular or plural.

Hereinafter, a preferred embodiments of a device and a method for improving the object recognition performance of an autonomous driving controller, according to an embodiment of the present disclosure, will be described in detail with reference to the accompanying drawings.

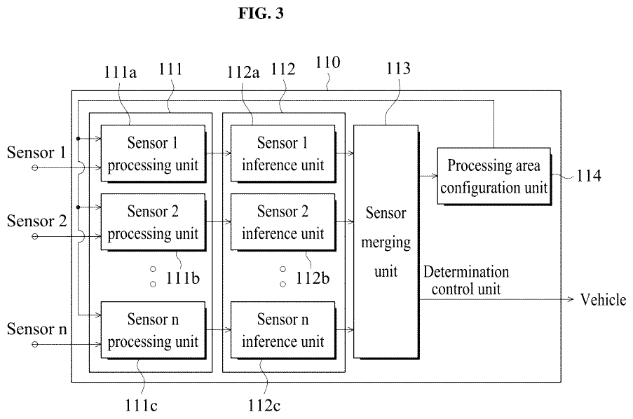

FIG. 2 is a block diagram illustrating a structure of a device for improving the object recognition performance of an autonomous driving controller according to an embodiment of the present disclosure. FIG. 3 is a block diagram illustrating a configuration of a recognition control unit of the device for improving the object recognition performance of an autonomous driving controller according to the embodiment in FIG. 2.

As illustrated in FIGS. 2 and 3, the device for improving the object recognition performance of an autonomous driving controller, according to an embodiment of the present disclosure, may include an object recognition module unit 100 and a sensor unit 200 so as to: recognize an object by using multiple different sensors; configure an intensive processing area of the sensors based on information about a position in which the object is recognized, thereby reducing the amount of computation of the autonomous driving controller through object recognition inference regarding the configured intensive processing area; and improve the recognition performance by minimizing raw data loss.

The object recognition module unit 100 may perform object recognition by receiving raw data from the sensor unit 200 including multiple sensors 210 and 220 to 230.

Furthermore, the object recognition module unit 100 may infer object recognition information regarding the position and type of an object detected from raw data, which is input from each sensor, by using a pre-installed inference program or a well-known inference program, and merge the inferred object recognition information for each sensor to perform object recognition.

Furthermore, the object recognition module unit 100 may mark a raw data area, in which an object is present, as an intensive processing area and control the intensive processing area to be reflected in the raw data input from each of the sensors 210 and 220 to 230.

Furthermore, the object recognition module unit 100 may output a preconfigured vehicle control signal to a vehicle in response to the recognized object information, such as a vehicle control signal to stop the vehicle if the recognized object is a person.

To this end, the object recognition module unit 100 may include a recognition control unit 110 and a determination control unit 120.

The recognition control unit 110 may receive raw data from the sensor unit 200 including the multiple sensors 210 and 220 to 230, and infer information about the position and type of an object from the raw data from each sensor by using an inference program.

Furthermore, the recognition control unit 110 may merge the inferred object recognition information for each sensor to recognize the object, and may mark a raw data area, in which the object is present, as an intensive processing area and control the intensive processing area to be reflected in the raw data received from the multiple sensors 210 and 220 to 230.

That is, the recognition control unit 110 may to reduce the amount of computation of the object recognition module unit 100 through object recognition inference regarding an intensive processing area from the input raw data.

Furthermore, the recognition control unit 110 may be configured to improve recognition performance by minimizing raw data loss while reducing the amount of computation in an inference procedure in which a large amount of computation is required for efficient object recognition, and may include a sensor processing unit 111, a sensor inference unit 112, a sensor merging unit 113, and a processing area configuration unit 114.

The sensor processing unit 111 may be configured to preprocess the raw data, which has been input from the sensor unit 200, by converting the raw data according to a preconfigured data size and format for inference, and may include a sensor 1 processing unit 111a and a sensor 2 processing unit 111b to a sensor n processing unit 111c, corresponding to the multiple sensors 210 and 220 to 230, to process raw data input from each sensor.

Furthermore, the sensor processing unit 111 may classify and correct the input raw data, extract valid data to extract an object and position information, and vectorize one or more pieces of extracted object data, and then perform preprocessing such as noise removal.

Furthermore, when intensive processing for preprocessing is configured for a predetermined area of raw data input from each sensor 210 and 220 to 230, the sensor processing unit 111 may preprocess a specific area of the input raw data into an intensive processing area, thereby reducing the amount of computation for object recognition inference and minimizing the loss of the raw data.

That is, an area that is likely to contain an object may be configured as an intensive processing area, thereby improving the accuracy and the computation speed.

Furthermore, when an intensive processing area of raw data is not configured, the sensor processing unit 111 may convert the entire area of the input raw data according to a preconfigured data size and format so that the entire area of the input raw data can be processed.

The sensor inference unit 112 may be an element configured to receive the raw data processed by the sensor processing unit 111 and infer information about the position and type of an object from the raw data from each of the sensors 210 and 220 to 230 by using an inference program, and may include a sensor 1 inference unit 112a and a sensor 2 inference unit 112b to a sensor n inference unit 112c, which correspond to the sensor 1 processing unit 111a and the sensor 2 processing unit 112b to the sensor n processing unit 111c of the sensor processing unit 111.

The inference program may analyze raw data, which has been input into the sensor 1 inference unit 112a and the sensor 2 inference unit 112b to the sensor n inference unit 112c, to extract feature points, and may infer objects based on an object inference algorithm to categorize the detected objects.

Furthermore, the inference program may infer an object with the highest value by analyzing the matching rate based on reference modeling, or may infer the object through a decision tree. A well-known inference program may also be used to infer the object.

The sensor merging unit 113 may determine the recognized object by merging the object recognition information for each of the sensors 210 and 220 to 230 inferred by the sensor inference unit 112, i.e., the object and the position information of the object extracted by the sensor processing unit 111, and object recognition information regarding the object based on the type of object inferred by the sensor inference unit 112.

Furthermore, the sensor merging unit 113 may output the recognized object information, for example, object information determined to be a person (or pedestrian), an animal, an object, etc. to the determination control unit 120.

Furthermore, the sensor merging unit 113 may mark a specific area of the raw data, that is, an area corresponding to information about a position in which the object extracted by the sensor processing unit 111 is present, as an intensive processing area and transmit the intensive processing area to the processing area configuration unit 114.

When the intensive processing area of the raw data is input from the sensor merging unit 113, the processing area configuration unit 114 reflects and updates the intensive processing area as information for intensive processing of the specific area of the raw data together with the sensor information, and transmits information about the updated intensive processing area to the sensor processing unit 111.

Furthermore, the processing area configuration unit 114 compares and analyzes the intensive processing area and the position information of the object, input from the sensor merging unit 113, to determine whether the position information of the object is the same as the previously configured intensive processing area. When the position information of the object and the intensive processing area are determined to be different, the intensive processing area of the raw data is updated. When the position information of the object and the intensive processing area are the same, the current configured intensive processing area is maintained.

This enables the sensor processing unit 111 to reflect the updated intensive processing area in the raw data input from a corresponding sensor and preprocess the raw data, thereby reducing the amount of computation of the autonomous driving controller through object recognition inference regarding the intensive processing area.

The determination control unit 120 outputs preconfigured vehicle control signals, for example, vehicle control signals such as vehicle stop, speed control, direction control, etc. to the vehicle in response to the object information recognized by the recognition control unit 110.

The sensor unit 200 may be installed in the vehicle to detect information related to the environment around the vehicle, such as the presence/absence and distance of people (or pedestrians) and objects, vehicle information and traffic information around the vehicle, and may include multiple sensors, such as sensor 1 210 and sensor 2 220 to sensor n 230.

Sensors 1 to n 210 and 220 to 230 may include one among a radar, a LIDAR, a camera, a 3D shape recognition sensor, a laser sensor, and a multi-axis motion sensor, but are not limited to the above sensors. Sensors 1 to n 210 and 220 to 230 may additionally include or may be replaced with various sensors for recognizing objects around the vehicle.

The following describes a method for improving the object recognition performance of an autonomous driving controller according to an embodiment of the present disclosure.

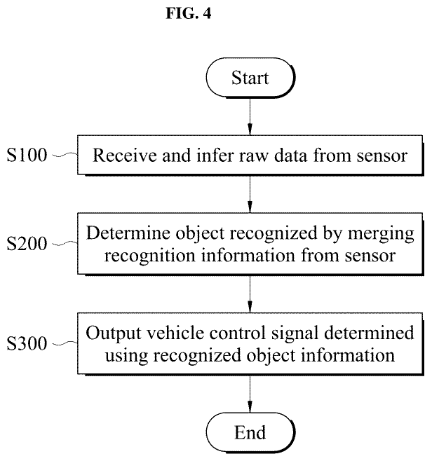

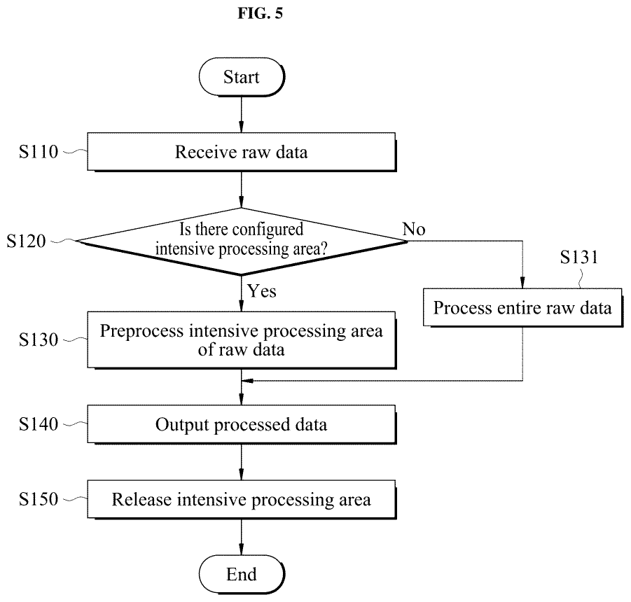

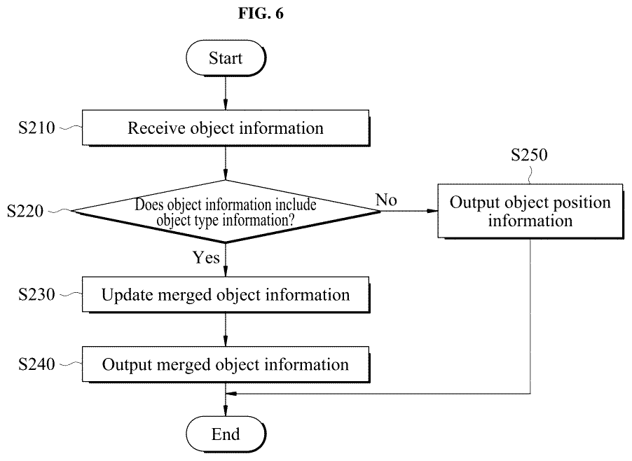

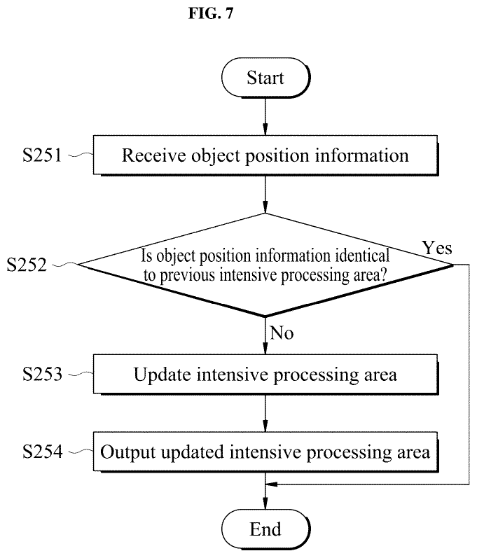

FIG. 4 is a flowchart illustrating a method for improving the object recognition performance of an autonomous driving controller according to an embodiment of the present disclosure. FIG. 5 is a flowchart illustrating a raw data processing process in the method for improving the object recognition performance of an autonomous driving controller according to the embodiment in FIG. 4. FIG. 6 is a flowchart illustrating an object information processing process in the method for improving the object recognition performance of an autonomous driving controller according to the embodiment in FIG. 4. FIG. 7 is another flowchart illustrating an object information processing process in the method for improving the object recognition performance of an autonomous driving controller according to the embodiment in FIG. 4.

As illustrated in FIGS. 2 to 7, in object recognition module unit 100 according to an embodiment of the present disclosure, a recognition control unit 110 may receive raw data from a sensor unit 200, which includes multiple sensors 210 and 220 to 230, and perform object recognition (S100).

Furthermore, in step S100, the recognition control unit 110 may infer object recognition information about the position and type of a detected object from the raw data input from each of the sensors 210 and 220 to 230 by using a pre-installed inference program or a well-known inference program.

The inference program may analyze the raw data input from each of the sensor 210 and 220 to 230 to extract feature points, and infer objects based on an object inference algorithm to categorize the detected objects. The inference program may infer an object having the highest value by analyzing the matching rate based on reference modeling, or may infer an object through a decision tree.

In step S100, when raw data is received from the sensors 210 and 220 to 230 of the sensor unit 200 (S110), the recognition control unit 110 may determine whether an intensive processing area for inference has been configured for the received raw data (S120).

When, as a result of the determination in step S120, it is determined that the intensive processing area for inference has been configured, the recognition control unit 110 converts and preprocesses a specific area of the raw data, which corresponds to the configured intensive processing area, according to a preconfigured data size and format (S130).

Furthermore, when, as a result of the determination in step S120, it is determined that the intensive processing area for inference has not been configured, the recognition control unit 110 converts and processes the entire area of the input raw data according to the preconfigured data size and format (S131).

The recognition control unit 110 outputs the raw data, which has been processed in steps S130 and S131, for inference (S140), and releases configured intensive processing area (S140).

Subsequently, the recognition control unit 110 may merge the inferred object recognition information for each sensor to recognize an object, and may determine the recognized object (S200).

To elaborate further on step 200, when the inferred object recognition information for each sensor is received (S210), the recognition control unit 110 determines whether the received object recognition information includes information about an object type (S220).

When, as a result of the determination in step S220, it is determined that the received object recognition information includes the information about the object type, the recognition control unit 110 identifies the information about the object type from inferred object recognition information from the other sensors, and updates the object information recognized by merging the identified information about the object type (S230).

Furthermore, the recognition control unit 110 outputs the recognized merged object information to a determination control unit 120 (S240), so that the determination control unit 120 may output a preconfigured vehicle control signal to a vehicle in response to the recognized merged object information.

On the other hand, when, as a result of the determination in step S220, it is determined that the received object recognition information does not include the information about the object type, the recognition control unit 110 analyzes the position information of the object, marks the position information of the object in raw data, and outputs the marked position information of the object to be reflected in the intensive processing area of the raw data received from the corresponding sensor in step S100 (S250).

In step S250, the recognition control unit 110 receives the position information of the object (S251), and analyzes the received position information of the object to determine whether the position information of the object is the same as the previously configured intensive processing area (S252).

When, as a result of the determination in step S252, the position information of the object is different from the previously configured intensive processing area, the intensive processing area of the raw data may be updated (S253). The updated intensive processing area may be reflected in the intensive processing area of the raw data configured in step S100, and may be preprocessed in raw data that is input from the corresponding sensor (S254).

Subsequently, when the recognition control unit 110 outputs the recognized object information to the determination control unit 120 in step S200, the determination control unit 120 outputs a preconfigured vehicle control signal to the vehicle in response to the received object information (S300).

Thus, it is possible to recognize an object by using raw data received from multiple different sensors, configure an intensive processing area of the raw data based on information about a position in which the object is recognized, and reduce the amount of computation of the autonomous driving controller through object recognition inference regarding the configured intensive processing area.

Furthermore, recognition performance may be improved by minimizing raw data loss while reducing the amount of computation in an inference procedure in which a large amount of computation is required for efficient object recognition.

Although the present disclosure has been described with reference to the preferred embodiment as above, those skilled in the art will understand that the present disclosure can be variously modified and changed without departing from the idea and scope of the present disclosure as set forth in the following claims.

Furthermore, the reference numbers in the claims of the present disclosure are provided solely for the clarity and convenience of description and are not intended to limit the disclosure. Additionally, in describing the embodiments, the thickness of the lines and the size of the elements, depicted in the drawings, may be exaggerated for the clarity and convenience of description.

Furthermore, the terms described above are defined in consideration of functions in the present disclosure. However, the terms may vary depending on the intentions or practices of the user or operator. Therefore, the interpretation of these terms should be made based on the content throughout the present specification.

Furthermore, even if not explicitly illustrated or described, it is evident that those skilled in the art to which the present disclosure belongs can make various modifications, which include the technical idea of the present disclosure, from the description of the present disclosure, and such modifications still fall within the scope of the present disclosure.

Furthermore, the embodiments described above with reference to the accompanying drawings are provided for the purpose of explaining the present disclosure, and the scope of the present disclosure is not limited to these embodiments.

What is claimed is:

1. A device for improving object recognition performance of an autonomous driving controller, the device comprising an object recognition module unit (100) configured to:
receive raw data from multiple sensors to recognize an object;
infer information about a position and a type of the object from raw data from each sensor by using a predetermined inference program, and merge the inferred object recognition information for each sensor to recognize the object; and
mark a raw data area, in which the object is present, as an intensive processing area and control the intensive processing area to be reflected in the raw data received from the multiple sensors.

2. The device of claim 1, wherein the object recognition module unit (100) is configured to output a preconfigured vehicle control signal to a vehicle in response to the recognized object information.

3. The device of claim 2, wherein the object recognition module unit (100) comprises:
a recognition control unit (110) configured to receive raw data from multiple sensors, infer information about a position and a type of an object from raw data from each sensor by using a predetermined inference program, merge the inferred object recognition information for each sensor to recognize the object, mark a raw data area, in which the object is present, as an intensive processing area, and control the intensive processing area to be reflected in the raw data received from the multiple sensors; and
a determination control unit (120) configured to output a preconfigured vehicle control signal to a vehicle in response to the recognized object information.

4. The device of claim 3, wherein the recognition control unit (110) comprises:
a sensor processing unit (111) configured to preprocess raw data received from each sensor according to a preconfigured data size and format;
a sensor inference unit (112) configured to receive the preprocessed raw data and infer information about a position and a type of an object from the raw data from each sensor by using the inference program;
a sensor merging unit (113) configured to merge the inferred object recognition information for each sensor to recognize the object, and mark a raw data area, in which the object is present, as an intensive processing area; and
a processing area configuration unit (114) configured to configure the intensive processing area of the raw data to be reflected in the raw data received from the sensor and preprocessed.

5. The device of claim 4, wherein the sensor comprises one among a radar, a LIDAR, a camera, a 3D shape recognition sensor, a laser sensor, and a multi-axis motion sensor.

6. A method for improving object recognition performance of an autonomous driving controller, the method comprising:
step a) in which a recognition control unit (110) of an object recognition module unit (100) receives raw data from multiple sensors and infers information about a position and a type of an object from raw data from each sensor by using a predetermined inference program;
step b) in which the recognition control unit (110) merges the inferred object recognition information for each sensor to recognize the object; and
step c) in which the recognition control unit (110) marks a raw data area, in which the object is present, as an intensive processing area and control the intensive processing area to be reflected in the raw data received from the multiple sensors.

7. The method of claim 6, further comprising step d) in which a determination control unit (120) of the object recognition module unit (100) outputs a preconfigured vehicle control signal to a vehicle in response to the object information recognized in step b).

8. The method of claim 7, wherein step a) comprises:
step a-1) in which in case that raw data is received from each sensor, the recognition control unit (110) determines whether an intensive processing area of the raw data has been configured;
step a-2) in which based on the determination result, the recognition control unit (110) preprocesses the intensive processing area of the raw data according to a preconfigured data size and format, or processes the entire raw data area according to the preconfigured data size and format; and
step a-3) in which the recognition control unit (110) outputs the processed raw data.

9. The method of claim 7, wherein step b) comprises:
step b-1) in which in case that the inferred object recognition information for each sensor is received, the recognition control unit (110) determines whether the object recognition information comprises information about an object type; and
step b-2) in which in case that, as a result of the determination, the object recognition information comprises the information about the object type, the recognition control unit (110) updates object information recognized by merging the inferred object recognition information for each sensor, and controls a preconfigured vehicle control signal to be output in response to the recognized object information.

10. The method of claim 9, further comprising step b-3) in which in case that, as a result of the determination in step b-1), the object recognition information does not comprise the information about the object type, the recognition control unit (110) controls position information of the object to be reflected in an intensive processing area of raw data received from the sensor.

11. The method of claim 10, wherein step b-3) further comprises step in which the recognition control unit (110) analyzes the position information of the object to determine whether the position information is identical to a previously configured intensive processing area, and, in case that the position information of the object is determined to be different from the previously configured intensive processing area, updates the intensive processing area of the raw data and configures the updated intensive processing area to be reflected in preprocessing.
